(19) United States
(12) Patent Application Publication
(10) Pub. No.: US 2014/0250269 A1
(43) Pub. Date: Sep. 4, 2014

(54) DECLUSTERED RAID POOL AS BACKUP FOR RAID VOLUMES

(71) Applicant: LSI CORPORATION, San Jose, CA (US)

(72) Inventors: Siddharth Suresh Shanbhag, Bangalore (IN); Pavan Gururaj, Bangalore (IN); Manoj Kumar Shetty H, Bangalore (IN); Reshma Rai Bellore, Bangalore (IN)

(73) Assignee: LSI CORPORATION, San Jose, CA (US)

(21) Appl. No.: 13/863,462

(22) Filed: Apr. 16, 2013

(30) Foreign Application Priority Data
Mar. 1, 2013 (IN) 908/CHE/2013

(51) Int. Cl. G06F 3/06

(52) U.S. Cl. CPC G06F 3/0689; G06F 3/0665; G06F 3/0619
USPC 711/114

(57) ABSTRACT

Storage data is distributed across a first plurality of physical disks in a first enclosure using at least one redundant array of independent disks (RAID) technique. This creates a plurality of virtual volumes. This plurality includes at least a first virtual volume and a second virtual volume. The storage data is copied (i.e., backed up) to a second plurality of physical disks in a second enclosure. The storage data in the second enclosure is distributed across the second plurality of physical disks according to a declustered RAID technique. The declustered RAID allocations each correspond to the virtual volumes created in the first enclosure.

### BACKGROUND

Mass storage systems continue to provide increased storage capacities to satisfy user demands. Photo and movie storage, and photo and movie sharing are examples of applications that fuel the growth in demand for larger and larger storage systems.

A solution to these increasing demands is the use of arrays of multiple inexpensive disks. These arrays may be configured in ways that provide redundancy and error recovery without any loss of data. These arrays may also be configured to increase read and write performance by allowing data to be read or written simultaneously to multiple disk drives. These arrays may also be configured to allow “hot-swapping” which allows a failed disk to be replaced without interrupting the storage services of the array. Whether or not any redundancy is provided, these arrays are commonly referred to as redundant arrays of independent disks (or more commonly by the acronym RAID). The 1987 publication by David A. Patterson, et al., from the University of California at Berkeley titled “A Case for Redundant Arrays of Inexpensive Disks (RAID)” discusses the fundamental concepts and levels of RAID technology.

RAID storage systems typically utilize a controller that shields the user or host system from the details of managing the storage array. The controller makes the storage array appear as one or more disk drives (or volumes). This is accomplished in spite of the fact that the data (or redundant data) for a particular volume may be spread across multiple disk drives.

### SUMMARY

An embodiment of the invention may therefore comprise a method of operating a storage system. The method includes distributing storage data across a first plurality of physical disks in a first enclosure using at least one redundant array of independent disks (RAID) technique to create a plurality of virtual volumes. This plurality of virtual volumes includes at least a first virtual volume and a second virtual volume. The storage data is copied to a second plurality of physical disks in a second enclosure. The storage data is distributed across the second plurality of physical disks according to a declustered RAID technique.

An embodiment of the invention may therefore further comprise a storage system that includes a first enclosure configured to distribute storage data across a first plurality of physical disks using at least one redundant array of independent disks (RAID) technique to create a plurality of virtual volumes. These virtual volumes include at least a first virtual volume and a second virtual volume. The system also includes a second enclosure configured to receive the storage data and distribute the storage data across a second plurality of physical disks according to a declustered RAID technique.

### BRIEF DESCRIPTION OF THE DRAWINGS

FIG. 1 is a block diagram of a storage system.

FIG. 2 is a flowchart of a method of operating a storage system.

FIG. 3 is a flowchart of a method of using a declustered RAID pool to backup RAID virtual volumes.

FIG. 4 is a block diagram of a computer system.

### DETAILED DESCRIPTION OF THE EMBODIMENTS

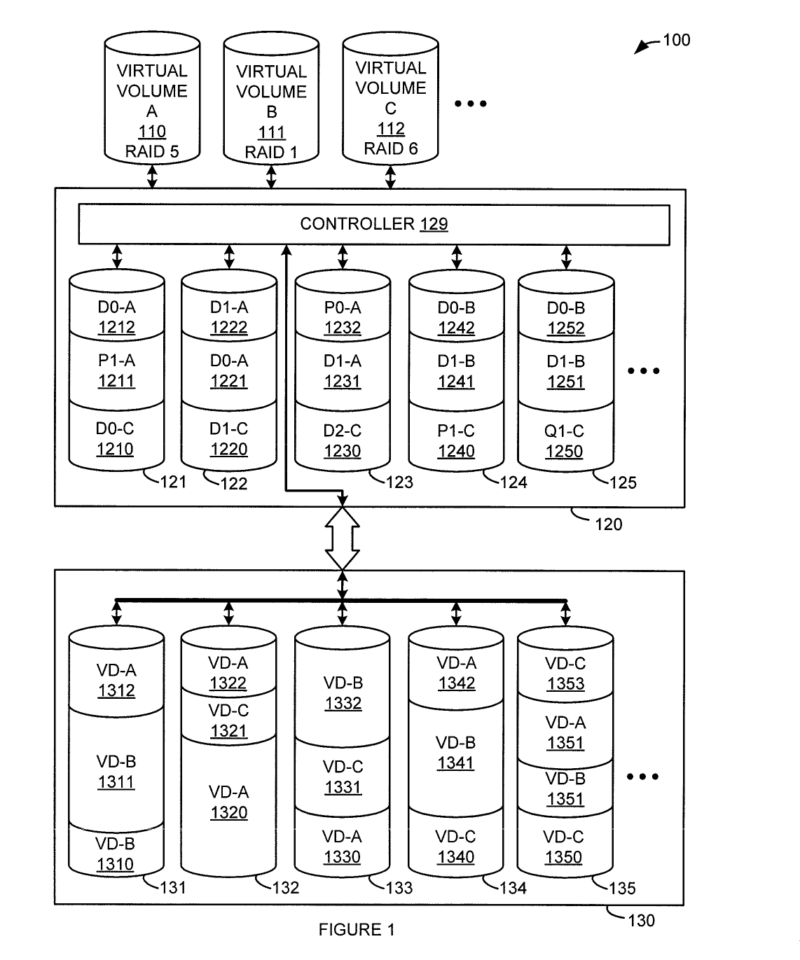

FIG. 1 is a block diagram of a storage system. In FIG. 1, storage system 100 comprises: disk enclosure 120; disk enclosure 130; virtual volume A 110; virtual volume B 111; and, virtual volume C 112. Disk enclosure 120 is operatively coupled to virtual volume A 110, virtual volume B 111, and, virtual volume C 112. Disk enclosure 120 is operatively coupled to disk enclosure 130.

Virtual volume 110 is shown configured as a RAID 5 volume. Virtual volume 111 is shown configured as a RAID 1 volume. Virtual volume 112 is shown configured as a RAID 6 volume. Storage system 100 may be configured to include more virtual volumes. However, these are omitted from FIG. 1 for the sake of brevity. Furthermore, virtual volumes 110-112 may be configured according to other RAID techniques (e.g., RAID 2).

Disk enclosure 120 includes controller 129, disk drive 121, disk drive 122, disk drive 123 disk drive 124, and disk drive 125. Controller 129 is operatively coupled to disk drives 121-125. Disk drives 121-125 may also be referred to as physical drives. Disk enclosure 120 may also include more disk drives. However, these are omitted from FIG. 1 for the sake of brevity.

Disk drive 121 includes stripes D0-C 1210, P1-A 1211, and D0-A 1212. Disk drive 122 includes stripes D1-C 1220, D0-A 1221, and D1-A 1222. Disk drive 123 includes stripes D2-C 1230, D1-A 1231, and P0-A 1232. Disk drive 124 includes stripes P1-C 1240, D1-B 1241, and D0-B 1242. Disk drive 235 includes stripes Q1-C 1250, D1-B 1251, and D0-B 1252.

The naming of stripes 1210-1250 is intended to convey the type of data stored, and the virtual volume to which, that data belongs. Thus, the name D0-A for stripe 1212 is intended to convey that stripe 1212 contains data block 0 (e.g., D0) for virtual volume A 110. D0-C is intended to convey that stripe 1210 contains data block 0 for virtual volume C 112. P0-A is intended to convey that stripe 1232 contains parity block 0 for virtual volume A 110. Q1-C is intended to convey that stripe 1250 contains second parity block 1 for virtual volume C 112, and so on. However, it should be understood that this distribution of data/stripes is merely illustrative. In an embodiment, storage system 100 may be configured to such that one or more (or all) of disk drives 121-125 may be dedicated to a single one of virtual volumes 110-112. For example, all of disk drive 124 and all of disk drive 125 may be dedicated to virtual volume B 111 in a RAID 1 configuration. Likewise, other RAID levels may be implemented by dedicating entire ones of disk drives 121-125 to one of virtual volumes 110-112.

Disk enclosure 130 includes disk drive 131, disk drive 132, disk drive 133 disk drive 134, and disk drive 135. Controller 129 is operatively coupled enclosure 130 and thereby to disk drives 131-135. Disk drives 131-135 may also be referred to as physical drives. Disk enclosure 130 may also include more disk drives. However, these are omitted from FIG. 1 for the sake of brevity.

Disk drive 131 includes declustered RAID (DRAID) allocation VD-B 1310, VD-B 1311, and VD-A 1312. Disk drive 132 includes DRAID allocation VD-A 1320, VD-C 1321, and VD-A 1322. Disk drive 133 includes DRAID allocation VD-A 1330, VD-C 1331, and VD-B 1332. Disk drive 134 includes DRAID allocation VD-C 1340, VD-B 1341, and VD-A 1342. Disk drive 135 includes DRAID allocation VD-C 1350, VD-B 1351, VD-A 1352 and VD-C 1353.

The naming of DRAID allocations 1310-1353 is intended to convey the virtual volume to which that data belongs. Thus, for example, the name VD-A for DRAID allocation 1312 is intended to convey that DRAID allocation 1312 contains data for virtual volume A 110; VD-B is intended to convey that DRAID allocation 1310 contains data for virtual volume B 111; VD-C is intended to convey that DRAID allocation 1331 contains data for virtual volume C 112; and so on.

It should be understood that virtual volumes 110-112 may be accessed by host computers (not shown). These host computers would typically access virtual volumes 110-112 without knowledge of the underlying RAID or declustered RAID structures created by controller 129. These host computers would also typically access virtual volumes 110-112 without knowledge of the underlying characteristics of disk enclosure 120 and disk enclosure 130.

Storage system 100 functions so that a DRAID pool created using disk enclosure 130 serves as back up pool for the created RAID volumes created using disk enclosure 120. Thus, if one or more of the created RAID volumes on disk enclosure 120 volume goes offline (i.e., fails), the DRAID pool created using disk enclosure 130 has backup data such that the I/O transactions are diverted to the DRAID pool created using disk enclosure 130. The I/O transactions that are diverted to the DRAID pool created using disk enclosure 130 are serviced by the DRAID allocations associated with the offline RAID virtual volume. In other words, if virtual volume B 111 were to go offline (due, for example, to a failure of disk 124 and disk 125), the I/O transaction directed to virtual volume B 111 are sent to disk enclosure 130 to be serviced by DRAID allocation 1311, DRAID allocation 1332, DRAID allocation 1341, and/or DRAID allocation 1351.

When data loss occurs on one or more of virtual volumes 110-112, I/O transactions resume on virtual volumes created on DRAID allocations 1310-1353. For example, as shown in FIG. 1, disk enclosure 120 is configured to store/retrieve virtual volume A 110 data using RAID 5, virtual volume B 111 data using RAID 1, and virtual volume C data using RAID 6. Disk enclosure 130 (and disks 131-135, in particular) are configured as a DRAID storage pool for the RAID 1, RAID 0, and RAID 5 volumes configured on disk enclosure 120. When there are no failures in disk enclosure 120, data may be backed up to disk enclosure 130. These backups may occur according to a schedule or at selected intervals. Thus, recent I/O transactions that complete on enclosure 120 also have corresponding I/O transactions that complete on enclosure 130. It should be understood that the various DRAID allocations 1310-1353 are each associated with virtual volumes 110-112 such that failures in disk enclosure 120 that result in a failure of a virtual volume 110-112 can be resumed using the associated DRAID allocations 1310-1353 in disk enclosure 130. Thus, I/O transactions sent to a failed virtual volume 110-112 can be serviced from disk enclosure 130 and thereby ensure data integrity.

In an embodiment, storage system 100 distributes storage data across disk drives 121-125 in disk enclosure 120 using at least one redundant array of independent disks (RAID) technique (e.g., RAID 0, RAID 1, etc.) to create virtual volumes 110-112. The storage data is copied to disk drives 131-135 in disk enclosure 130. The storage data corresponding to virtual volumes 110-112 is distributed across disk drives 131-135 in disk enclosure 130 according to a declustered RAID technique (e.g., CRUSH algorithm).

I/O requests made to, for example, virtual volume A 110 may be responded to using data from disk enclosure 130 when at least one of disk drives 121-125 in disk enclosure 120 has failed. In other words, after at least one of disk drives 121-125 in disk enclosure 120 has failed, storage system 100 may receive I/O requests directed to virtual volume A 110. These requests may be relayed to disk enclosure 130. Disk enclosure 130 may respond to these relayed requests using data read/written from/to the DRAID allocations 1310-1350 that are associated with virtual volume A 110.

Storage system 100 can detect that at least one of disk drives 121-125 in disk enclosure is in a failure condition (or about to be in a failure condition). In response to this failure condition, storage system 100 can relay I/O requests directed to virtual volumes 110-112 (e.g., virtual volume B 111) to disk enclosure 130. Disk enclosure 130 may respond to these relayed I/O requests using data from/to the DRAID pool on disk drives 131-135. The DRAID allocations 1310-1350 are each associated with a respective virtual volume 110-112. Thus, disk enclosure 130 responds to these relayed I/O requests using data from/to the appropriate associated DRAID allocations 1310-1350.

Storage system 100 can detect that the failure condition has been fixed. In response to the lack of the failure condition, storage system 100 can copy data disk enclosure 130 to disk enclosure 120. In this manner, storage system 100 can return to services all I/O transactions using disk enclosure 120.

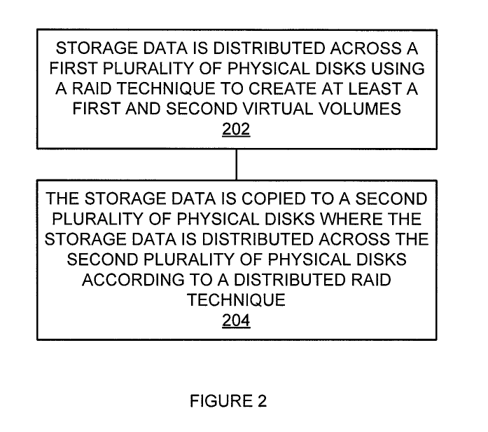

FIG. 2 is a flowchart of a method of operating a storage system. The steps illustrated in FIG. 2 may be performed by one or more elements of storage system 100. Storage data is distributed across a first plurality of physical disks using a RAID technique to create at least a first and second virtual volume (202). For example, controller 129 may be configured to distribute data across disk drives 121-125 according to RAID techniques to create virtual volumes 110-112. Data associated with virtual volume A 110 may be distributed by controller 129 across disk drives 121-125 according to, for example, the RAID 5 technique. Data associated with virtual volume B 111 may be distributed by controller 129 across disk drives 121-125 according to, for example, the RAID 1 technique. Data associated with virtual volume C 112 may be distributed by controller 129 across disk drives 121-125 according to, for example, the RAID 6 technique.

The storage data is copied to a second plurality of physical disks where the storage data is distributed across the second plurality of physical disks according to a declustered RAID technique (204). For example, controller 129 may be configured to distribute data across disk drives 131-135 according to a DRAID technique. Various DRAID allocations (e.g., DRAID allocations 1310-1350) may each be associated with the virtual volumes 110-112 created on disk enclosure 120. The declustered RAID technique may be the CRUSH algorithm.

I/O requests made to the first virtual volume may be responded to using data from the second enclosure when at least one of the first plurality of disks has failed. For example, when disk drive 122 has failed, this may cause a failure of virtual volume B 111. Storage system 100 may respond to I/O requests made to virtual volume B 111 after this failure using data associated with virtual volume B 111 that is on DRAID allocations 1310, 1311, 1332, 1341, and/or 1351.

I/O requests directed to the first virtual volume may be received. For example storage system 100 may receive I/O requests from a host system that are directed to virtual volume C 112. These I/O requests may be relayed to the second enclosure. For example, storage system may, when there is a failure in disk enclosure 120 that causes a failure of virtual volume C, relay I/O requests directed to virtual volume C 112 to disk enclosure 130. Enclosure 130 may respond to these relayed I/O requests made to virtual volume C 112 using data associated with virtual volume C 112 that is on DRAID allocations 1321, 1331, 1340, 1350, and/or 1353.

It may be detected that at least one of the first plurality of physical disks is in a failure condition. For example, storage system 100 (or controller 129, in particular) may detect that at least one of disk drives 121-125 has failed (or is about to fail). In response to the failure condition, I/O requests directed to the first virtual volume are relayed to the second enclosure. For example, in response to detecting that at least one of disk drives 121-125 has failed thereby resulting in a failure of virtual volume C 112, storage system 100 may relay I/O requests directed to virtual volume C 112 to disk enclosure 130.

It may be detected that the failure condition has been fixed. For example, storage system 100 (or controller 129, in particular) may detect that the at least one failed disk drive(s) 121-125 has been fixed or replaced. In response to the lack of a failure condition, data is copied from the second enclosure to the first enclosure. For example, when storage system 100 (or controller 129, in particular) detect that the at least one failed disk drive(s) 121-125 has been fixed or replaced, storage system 100 may copy some or all of the data (and/or parity) from the DRAID allocations 1310-1353 associated with virtual volume C 112 (i.e., DRAID allocations 1321, 1331, 1340, 1350, and 1353) to the RAID stripes in disk enclosure 120 associated with virtual volume C 112 (i.e., stripes 1210, 1220, 1230, 1240, and 1250).

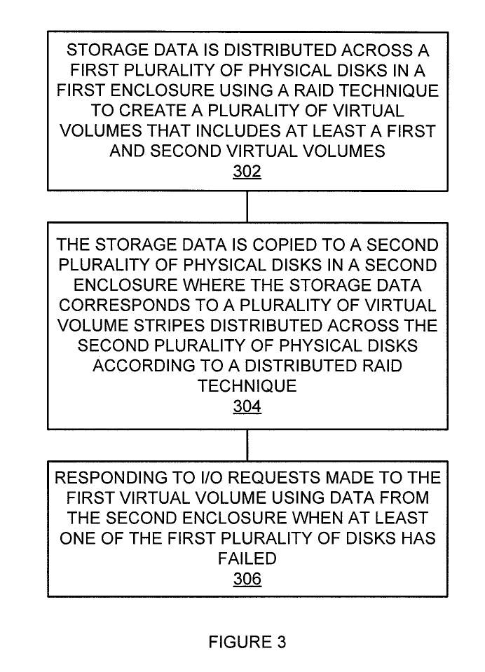

FIG. 3 is a flowchart of a method of using a declustered RAID pool to backup RAID virtual volumes. The steps illustrated in FIG. 3 may be performed by one or more elements of storage system 100. Storage is distributed across a first plurality of physical disks in a first enclosure using a RAID technique to create a plurality of virtual volumes that includes at least a first virtual volume and a second virtual volume (302). For example, controller 129 may be configured to distribute data across disk drives 121-125 in disk enclosure 120 according to RAID techniques to create virtual volumes 110-112. Data associated with virtual volume A 110 may be distributed by controller 129 across disk drives 121-125 in disk enclosure 120 according to, for example, the RAID 5 technique. Data associated with virtual volume B 111 may be distributed by controller 129 across disk drives 121-125 in disk enclosure 120 according to, for example, the RAID 1 technique. Data associated with virtual volume C 112 may be distributed by controller 129 across disk drives 121-125 in disk enclosure 120 according to, for example, the RAID 6 technique.

The storage data is copied to a second plurality of physical disks in a second enclosure where the storage data corresponds to a plurality of virtual volume stripes distributed across the second plurality of physical disks according to a declustered RAID technique (304). For example, storage system 100 may copy the data in stripes 1210-1252 (which correspond to virtual volumes 110-112) to disk drives 130-135 in disk enclosure 130. The data in stripes 1210-1252 (or the stripes 1210-1252 themselves) may be distributed across disk drives 130-135 in disk enclosure 130 according to a DRAID technique (e.g., the CRUSH algorithm).

I/O requests made to the first virtual volume are responded to using data from the second enclosure when at least one of the first plurality of disks has failed (306). For example, when at least one of disk drives 121-125 in disk enclosure 120 has failed, thereby resulting in a failure of, for example, virtual volume B 111, I/O requests made to virtual volume B 111 may be responded to using data on DRAID allocations 1310, 1311, 1332, 1341, and/or 1351.

The methods, systems, drives controller, equipment, and functions described above may be implemented with or executed by one or more computer systems. The methods described above may also be stored on a computer readable medium. Elements of storage system 100, may be, comprise, include, or be included in, computers systems.

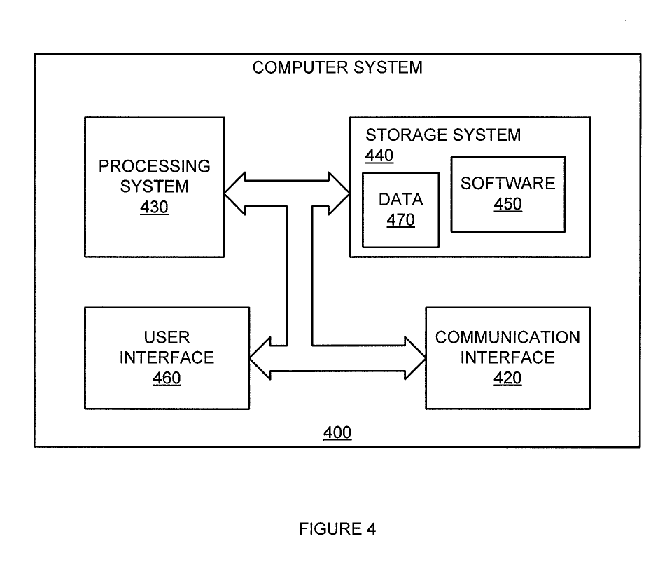

FIG. 4 illustrates a block diagram of a computer system. Computer system 400 includes communication interface 420, processing system 430, storage system 440, and user interface 460. Processing system 430 is operatively coupled to storage system 440. Storage system 440 stores software 450 and data 470. Processing system 430 is operatively coupled to communication interface 420 and user interface 460. Computer system 400 may comprise a programmed general-purpose computer. Computer system 400 may include a microprocessor. Computer system 400 may comprise programmable or special purpose circuitry. Computer system 400 may be distributed among multiple devices, processors, storage, and/or interfaces that together comprise elements 420-470.

Communication interface 420 may comprise a network interface, modem, port, bus, link, transceiver, or other communication device. Communication interface 420 may be distributed among multiple communication devices. Processing system 430 may comprise a microprocessor, microcontroller, logic circuit, or other processing device. Processing system 430 may be distributed among multiple processing devices. User interface 460 may comprise a keyboard, mouse, voice recognition interface, microphone and speakers, graphical display, touch screen, or other type of user interface device. User interface 460 may be distributed among multiple interface devices. Storage system 440 may comprise a disk, tape, integrated circuit, RAM, ROM, network storage, server, or other memory function. Storage system 440 may be a computer readable medium. Storage system 440 may be distributed among multiple memory devices.

Processing system 430 retrieves and executes software 450 from storage system 440. Processing system 430 may retrieve and store data 470. Processing system 430 may also retrieve and store data via communication interface 420. Processing system 430 may create or modify software 450 or data 470 to achieve a tangible result. Processing system 430 may control communication interface 420 or user interface 460 to achieve a tangible result. Processing system 430 may retrieve and execute remotely stored software via communication interface 420.

Software 450 and remotely stored software may comprise an operating system, utilities, drivers, networking software, and other software typically executed by a computer system. Software 450 may comprise an application program, applet, firmware, or other form of machine-readable processing instructions typically executed by a computer system. When executed by processing system 430, software 450 or remotely stored software may direct computer system 400 to operate as described herein.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of operating a storage system, comprising:
distributing storage data across a first plurality of physical disks in a first enclosure using at least one redundant array of independent disks (RAID) technique to create a plurality of virtual volumes comprising at least a first virtual volume and a second virtual volume;
copying the storage data to a second plurality of physical disks in a second enclosure, the storage data is distributed across the second plurality of physical disks according to a declustered RAID technique.

2. The method of claim 1, wherein the declustered RAID technique is the CRUSH algorithm.

3. The method of claim 1, further comprising:
responding to I/O requests made to said first virtual volume using data from the second enclosure when at least one of the first plurality of disks has failed.

4. The method of claim 1, further comprising:
receiving I/O requests directed to the first virtual volume;
relaying the I/O request directed to the first virtual volume to the second enclosure.

5. The method of claim 1, further comprising:
detecting that at least one of the first plurality of physical disks is in a failure condition;
in response to the failure condition, relaying I/O requests directed to the first virtual volume to the second enclosure.

6. The method of claim 5, further comprising:
detecting that the failure condition has been fixed;
in response a lack of the failure condition, copying data from the second enclosure to the first enclosure.

7. A storage system, comprising:
a first enclosure configured to distribute storage data across a first plurality of physical disks using at least one redundant array of independent disks (RAID) technique to create a plurality of virtual volumes comprising at least a first virtual volume and a second virtual volume;
a second enclosure configured to receive the storage data and distribute the storage data across a second plurality of physical disks according to a declustered RAID technique.

8. The storage system of claim 7, wherein the declustered RAID technique is the CRUSH algorithm.

9. The storage system of claim 7, wherein I/O requests made to said first virtual volume are responded to using data from the second enclosure when at least one of the first plurality of disks has failed.

10. The storage system of claim 7, wherein I/O requests directed to the first virtual volume are relayed to the second enclosure.

11. The storage system of claim 10, wherein in response to a failure condition of at least one of the first plurality of physical I/O requests directed to the first virtual volume are directed to the second enclosure.

12. The storage system of claim 11, in response a lack of the failure condition, data is copied from the second enclosure to the first enclosure.

13. A non-transitory computer readable medium having instructions stored thereon for operating a storage system that, when executed by a computer, at least instruct the computer to:
distribute storage data across a first plurality of physical disks in a first enclosure using at least one redundant array of independent disks (RAID) technique to create a plurality of virtual volumes comprising at least a first virtual volume and a second virtual volume;
copy the storage data to a second plurality of physical disks in a second enclosure, the storage data distributed across the second plurality of physical disks according to a declustered RAID technique.

14. The medium of claim 13, wherein the declustered RAID technique is the CRUSH algorithm.

15. The medium of claim 13, wherein the computer is further instructed to:
respond to I/O requests made to said first virtual volume using data from the second enclosure when at least one of the first plurality of disks has failed.

16. The medium of claim 13, wherein the computer is further instructed to:
receive I/O requests directed to the first virtual volume;
relay the I/O request directed to the first virtual volume to the second enclosure.

17. The medium of claim 13, wherein the computer is further instructed to:
detect that at least one of the first plurality of physical disks is in a failure condition;
in response to the failure condition, relay I/O requests directed to the first virtual volume to the second enclosure.

18. The medium of claim 17, wherein the computer is further instructed to:
detect that the failure condition has been fixed;
in response a lack of the failure condition, copy data from the second enclosure to the first enclosure.
